(19) United States
(12) Patent Application Publication
(10) Pub. No.: US 2011/0254774 A1
(43) Pub. Date: Oct. 20, 2011

(54) TERMINAL DEVICE AND RECORDING MEDIUM WITH CONTROL PROGRAM RECORDED THEREIN

(75) Inventors: Shinya YAMAMOTO, Kawasaki (JP); Hideaki AIHARA, Kawasaki (JP)

(73) Assignee: NEC CASIO MOBILE COMMUNICATIONS, LTD., Kanagawa (JP)

(21) Appl. No.: 13/090,519

(22) Filed: Apr. 20, 2011

(30) Foreign Application Priority Data
Apr. 20, 2010 (JP) 2010-096755

(51) Int. Cl. G06F 3/02; G06F 3/041; G06F 3/01

(52) U.S. Cl. 345/169; 345/156; 345/173

(57) ABSTRACT

In a terminal device 100 which includes a display section housing 1 having a display section 4 and a display section housing 2 having a display section 5 foldably connected via a hinge section 3, when a control section 11 judges that one of the display section housings 1 and 2 is substantially horizontal with respect to the gravitational force direction and a display section included in the substantially horizontal display section housing is facing upwards with respect to the gravitational force direction, and further judges that the opening angle of the display section housings 1 and 2 is greater than a predetermined angle, the display of the display section included in the display section housing judged to be substantially horizontal with respect to the gravitational force direction is switched to display for inputting text.

### CROSS-REFERENCE TO RELATED APPLICATION

This application is based upon and claims the benefit of priority from the prior Japanese Patent Application No. 2010-096755, filed Apr. 20, 2010, the entire contents of which is incorporated herein by reference.

### BACKGROUND OF THE INVENTION

1. Field of the Invention

The present invention relates to a terminal device structured by two housings respectively having a display section being foldably connected via a hinge section, and a recording medium with a control program for the terminal device recorded therein.

2. Description of the Related Art

In recent years, terminal devices such as mobile phones have become increasingly sophisticated, and the screen size has been increased along with it. However, the screen size is limited due to their portability, and therefore the increase of the screen size has been actualized by a plurality of display sections being provided. For example, in a terminal device whose two housings are foldably connected via a hinge section, the increase of the screen size is actualized by a display section being provided in each housing and these two display sections being openable in a manner similar to a book.

An openable type terminal device such as this is used in a manner similar to a book by information amounting to a plurality of pages being allocated to and displayed on the display sections. In addition, the terminal device is used such that a software keyboard (touch-panel-type keyboard) is displayed on one display section, and text inputted from the software keyboard is displayed on the other display section. In this case, a special key operation is required to be performed to display the software keyboard on the display section. Therefore, conventionally, a technology has been disclosed in which a software keyboard is automatically displayed on a display section, for example, when a text input instruction included in display information is detected (for example, refer to Japanese Patent Application Laid-Open (Kokai) Publication No. 2003-076477).

However, although the keyboard can be automatically displayed without a special operation being performed, there is a problem in the above described technology. For example, the user may not necessarily wish to input text even when a text input instruction is included in display information. In this case, when the keyboard is needlessly displayed, a new operation for canceling the keyboard display is required to be performed, which places an unnecessary burden on the user.

### SUMMARY OF THE INVENTION

An object of the present invention is to enable the display of either one of two display sections to be switched to display for inputting text in accordance with the intentions of a user attempting to input text, without a special key operation being performed.

In accordance with one aspect of the present invention, there is provided a terminal device which includes two housings respectively having a display section which are foldably connected via a hinge section, comprising: a tilt judgment means for detecting an angle of each housing with respect to a gravitational force direction, and judging whether or not either one of the two housings is substantially horizontal with respect to the gravitational force direction and the display section included in the substantially horizontal housing is facing upwards with respect to the gravitational force direction; an opening angle judgment means for detecting an opening angle of the two housings, and judging whether or not the opening angle is greater than a predetermined angle; and a display control means for switching display of the display section included in a housing judged to be substantially horizontal with respect to the gravitational force direction to display for inputting text, when the tilt judgment means judges that one housing is substantially horizontal with respect to the gravitational force direction and the display section included in the substantially horizontal housing is facing upwards with respect to the gravitational force direction, and the opening angle judgment means judges that the opening angle is greater than the predetermined angle.

In accordance with another aspect of the present invention, there is provided a non-transitory computer-readable storage medium having stored thereon a program that is executable by a computer, the program being executable by the computer to perform functions comprising: processing for detecting angles of two housings respectively having a display section which are foldably connected via a hinge section, with respect to a gravitational force direction, and judging whether or not either one of the two housings is substantially horizontal with respect to the gravitational force direction and the display section included in the substantially horizontal housing is facing upwards with respect to the gravitational force direction; processing for detecting an opening angle of the two housings, and judging whether or not the opening angle is greater than a predetermined angle; and processing for switching display of the display section included in the housing judged to be substantially horizontal with respect to the gravitational force direction to display for inputting text, when one housing is judged to be substantially horizontal with respect to the gravitational force direction, the display section included in the substantially horizontal housing is judged to be facing upwards with respect to the gravitational force direction, and the opening angle is judged to be greater than the predetermined angle.

According to the present invention, the display of either one of two display sections can be switched to display for inputting text in accordance with the intentions of a user attempting to perform text input, without a special key operation being performed. As a result, the user-friendliness is improved.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A and FIG. 1B are diagrams for explaining display status based on changes in the style of a mobile phone 100 to which the present invention has been applied;

FIG. 2 is a block diagram showing basic components of the mobile phone 100;

FIG. 3 is a flowchart outlining operations of the characteristic portion (application processing) of an embodiment from among all of the operations of the mobile phone 100;

FIG. 4 is a flowchart showing operations subsequent to the operations in FIG. 3;

FIG. 5A and FIG. 5B are diagrams for explaining other display status (other display status differing from those in FIG. 1A and FIG. 1B) based on changes in the style of the mobile phone 100; and

FIG. 6A and FIG. 6B are also diagrams for explaining other display status (other display status differing from those in FIG. 1A and FIG. 1B, and in FIG. 5A and FIG. 5B).

### DETAILED DESCRIPTION OF THE PREFERRED EMBODIMENTS

The present invention will hereinafter be described in detail with reference to the preferred embodiment shown in the accompanying drawings.

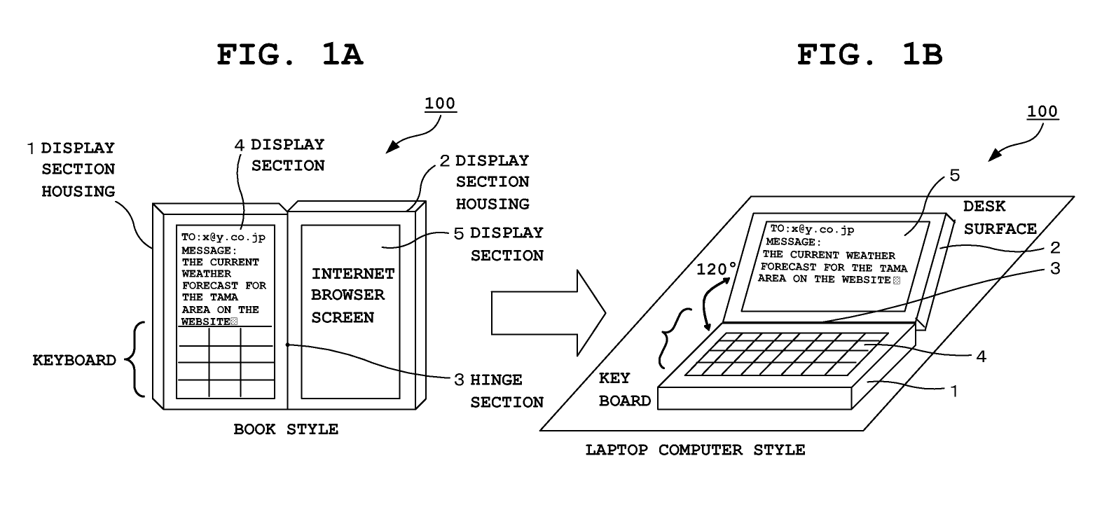

The present embodiment is an example in which the present invention has been applied to a mobile phone 100. FIG. 1A and FIG. 1B are outer appearance views of the mobile phone 100, which is used for explaining display status based on changes in the style of the mobile phone 100.

The mobile phone 100 has a call function, an electronic mail function, an Internet connection function (web access function), a television receiving function, an electronic book viewing function, etc. As shown in FIG. 1A and FIG. 1B, the mobile phone 100 is a foldable (openable) type mobile phone which includes two housings respectively having a display section that are a display section housing 1 and a display section housing 2 foldably connected (so as to be openable and closable) via a hinge section 3. The electronic book viewing function is a function that allocates data amounting to a plurality of pages to the respective display sections of the display section housings 1 and 2, and displays the data in the page sequence.

The display section housing 1 includes a display section 4, and the display section housing 2 includes a display section 5. These display section housings 1 and 2 are respectively composed of rectangular bodies of the same shape and size. In FIG. 1A, the vertically long display housings 1 and 2 are in an opened state where they are horizontally aligned (horizontally opened state). That is, the display housings 1 and 2 are in a vertically oriented state where the overall terminal housing is horizontally long. In this vertically oriented state (horizontally opened state), the display section housing 1 is positioned on the left side and the display section housing 2 is positioned on the right side in FIG. 1. The hinge section 3 is a connecting section enabling the display section housings 1 and 2 to be openable and closable, by which they can be changed from an overlapped state to an opened state (a state in which the display section housings 1 and 2 are opened at substantially 180°). An opened state such as that shown in FIG. 1A will hereinafter be referred to as “book style”. In this book style, the display section 4 included in the display section housing 1 and the display section 5 included in the display section housing 2 are closely aligned horizontally.

The display sections 4 and 5, which are rectangular liquid crystal display sections or organic electroluminescent (EL) sections having the same shape and size, are arranged on substantially the overall front surfaces of the display section housings 1 and 2. In the example shown in FIG. 1A, two functions (applications) are running simultaneously in the two display sections 4 and 5 (the user is running and viewing two functions with separate display sections). Specifically, a mail creating function, which is a function that requires text input, is running in the display section 4 included in the display section housing 1 positioned on the left side in FIG. 1A. On the lower-half of the display section 4, a ten-key type keyboard for inputting text is displayed as a software keyboard (touch-panel-type keyboard). Also, on the upper-half of the display section 4, mail contents being created by the mail creating function requiring text input are displayed. In addition, in the display section 5 included in the display section housing 2 positioned on the right side in FIG. 1A, an internet browser function, which is a viewing/listening function that does not require text input, is running and therefore an internet browser screen, which does not require text input, is being displayed in the overall area thereof.

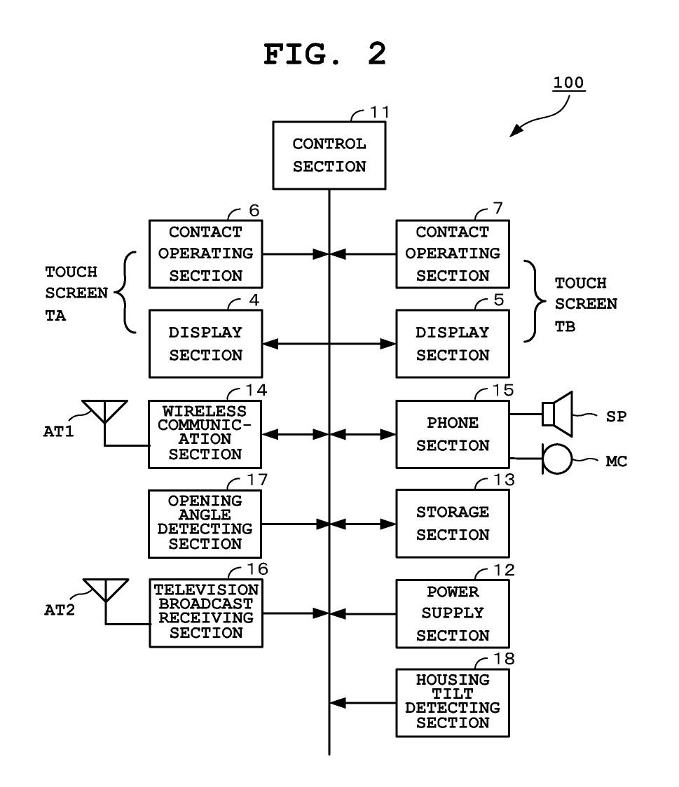

FIG. 2 is a block diagram showing basic components of the mobile phone 100.

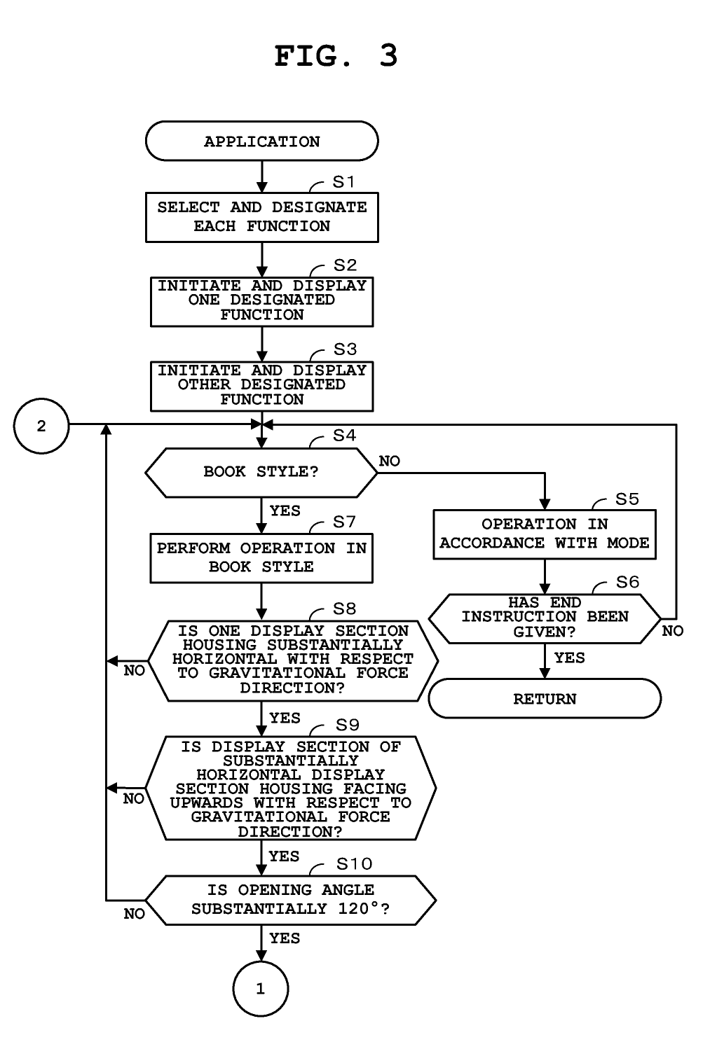

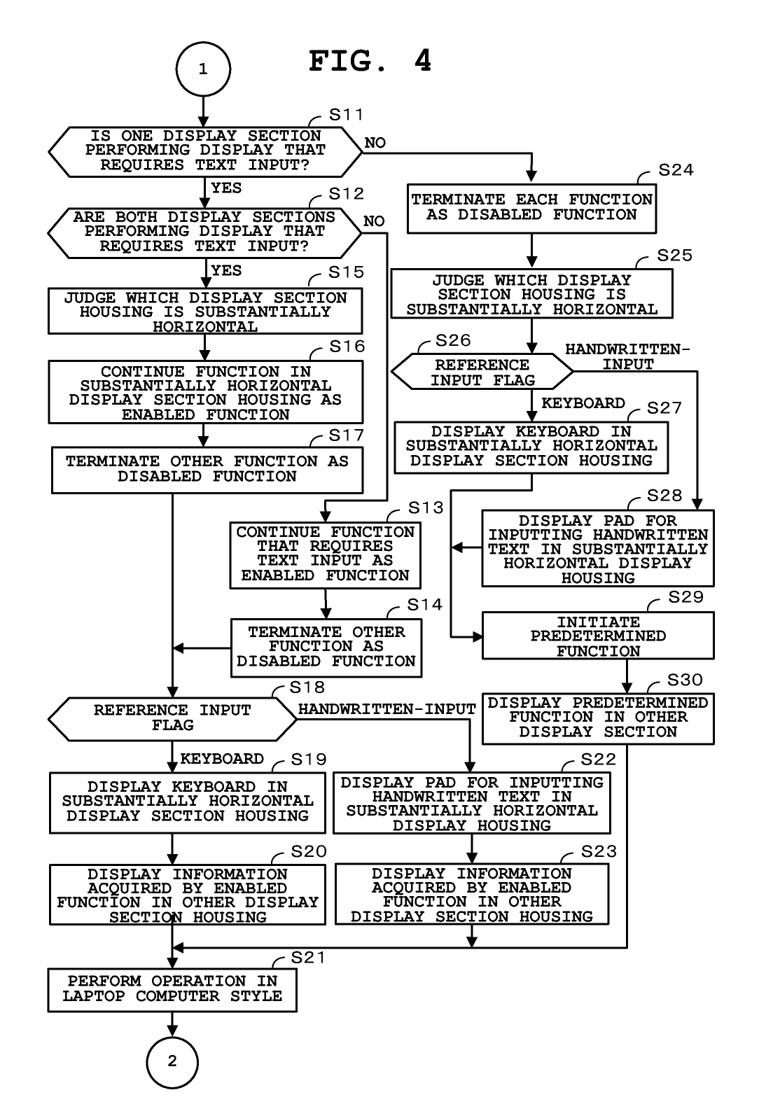

A control section 11 (tilt judgment means, opening angle judgment means, display control means, and text input judgment means), which operates by receiving power supply from a power supply section 12 including a rechargeable battery, is provided with a central processing unit (CPU), a memory, and the like (not shown), and controls the overall operations of the mobile phone 100 in accordance with various programs stored in a storage section 13. The storage section 13 is an internal memory, such as a read-only memory (ROM) or a random access memory (RAN), and has a program area and a data area (not shown). The program area of the storage section 13 stores programs for actualizing the present embodiment based on operation procedures shown in FIG. 3 and FIG. 4 described hereafter, and the data area of the storage section 13 stores various flag information and various information required to operate the mobile phone 100. Note that the storage section 13 may be, for example, structured to include a detachable portable memory (recording media) such as a secure digital (SD) card or an integrated circuit (IC) card. Alternatively, the storage section 13 may be structured to be provided on a predetermined external server (not shown).

The display sections 4 and 5 constitute touch screens TA and TB, and the touch screens TA and TB are structured by contact operating sections (transparent touch panels) 6 and 7 being layered over the display sections 4 and 5. The contact operating sections 6 and 7 correspond to the surfaces of the display sections 4 and 5, and detect finger contact. Note that the touch panels 6 and 7 may use a capacitance method, a resistive film method, or a piezoelectric method that enables the detection of pressing (pressure) by an operating instrument or a finger, in addition to contact. In the present embodiment, the piezoelectric method, which enables the detection of pressure by an operating instrument (pen) or a finger, is used.

The display sections 4 and 5 (touch screens TA and TB), on which a software keyboard (touch-panel-type keyboard) or a software pad for inputting handwritten text (touch pad: touch-panel-type pad for inputting handwritten text) is displayed, are used to dial a number, enter text, enter a command, etc. The control section 11 performs various types of processing such as transmission processing, and electronic mail reception processing as processing based on operation signals sent from the touch screens TA and TB. In addition, the touch screens TA and TB display a standby screen image, icons, date and time information, text data, mail, web pages, and the like.

A wireless communication section 14 includes a wireless section, a baseband section, a demultiplexing section, and the like (not shown), and exchanges data with the nearest base station during the operation of, for example, the voice call function, the electronic mail function, or the internet connection function. When the call function is running, the wireless communication section 14 receives signals from the receiving side of the baseband section, and after demodulating the signals into reception baseband signals, outputs the reception baseband signals as audio from a call speaker SP via a phone section 15. The wireless communication section 14 also receives, from the phone section 15, audio data inputted from a call microphone MC, and after encoding the audio data into transmission baseband signals, sends the encoded transmission baseband signals to the transmitting side of the baseband section, and transmits the encoded transmission baseband signals from an antenna AT. A television broadcast receiving section 16 includes a receiving section (analog circuit section) and a digital circuit section, and receives terrestrial digital television broadcasts. The receiving section extracts broadcast signals from an antenna AT2. The digital circuit section demodulates received broadcast signals into orthogonal frequency-division multiplex (OFDM) signals; separates multiplexed broadcast signals into video, audio, and data (text data) signals and decodes the signals; or decompresses compressed data.

An opening angle detecting section 17 is provided in the hinge section 3, and detects an angle (opening angle) at which the display section housings 1 and 2 are opened. The function of the opening angle judgment means is actualized by this opening angle detecting section 17 and the control section 11. Note that the opening angle detecting section 17 has a rotary-type switch structure in which an opening angle (for example, 0° to 180°) is detected by a movable contact that rotates with the rotation of the hinge section 3 coming into contact with a fixed contact. However, the structure of the opening angle detecting section 17 may be arbitrarily determined, and may be a structure in which an opening angle is detected optically or magnetically. In addition, this opening angle is not limited to 0° to 180°, and may be 0° to 360°. The control section 11 judges whether or not an opening angle is a predetermined angle (about 120° in the present embodiment) based on a detection result from the opening angle detecting section 17. Also note that, although “about 120°” herein refers to 110° to 130°, it is not limited thereto, and may be 100° to 120°.

A housing tilt detecting section 18 is a three-axis-type acceleration sensor that detects a tilt angle of each display section housing 1 and 2 in a direction in which the display section housings 1 and 2 are opened, when the display section housings 1 and 2 are in an opened state with the hinge section 3 therebetween. The function of the tilt judgment means is actualized by this housing tilt detecting section 18 and the control section 11. The housing tilt detecting section 18, which is mounted on a substrate inside the display section housing 1 and a substrate inside the display section housing 2, detects the respective angles of the display section housings 1 and 2 with respect to the gravitational force direction, and detects whether or not a display section housing is substantially horizontal with respect to the gravitational force direction, and the display section included in the substantially horizontal display section housing is facing upwards with respect to the gravitational force direction. Based on a detection results from the housing tilt detecting section 18, the control section 11 judges which of the two display section housing 1 and 2 is substantially horizontal, and further judges whether or not a display section included in a display section housing judged to be substantially horizontal is facing upwards. Then, based on detection results from the opening angle detecting section 17 and the housing tilt detecting section 18, the control section 11 switches the display of a display section included in one of the two display section housings 1 and 2 that has been placed on a desk surface or the like (the substantially horizontal display section housing) to display for inputting text.

That is, when the control section 11 judges that one display section housing is substantially horizontal with respect to the gravitational force direction and the display section included in the substantially horizontal display section housing is facing upwards with respect to the gravitational force direction, and further judges that the opening angle is greater than a predetermined angle, the control section 11 switches the display of the display section included in the display section housing judged to be substantially horizontal with respect to the gravitational force direction to display for inputting text. FIG. 1B shows an example in which one display section housing is placed on a desk surface or the like (substantially horizontal display section housing), and the opening angle is substantially 120°. Hereinafter, this state is referred to as “laptop computer style”.

In the example in FIG. 1B, the display section housing 1 has been placed on a desk surface or the like and therefore is in a substantially horizontal state. Accordingly, a software keyboard (touch-panel-type full keyboard) is displayed on the display section 4 included in the display section housing 1, as display for inputting text. In addition, on the display section 5 included in the other display section housing 2, the contents displayed on the display section 4 in the book style shown in FIG. 1A as display that requires text input (the mail contents being created) is continued to be displayed as they are. Note that, in the present embodiment, text refers to a wide variety of information including Japanese hiragana and katakana characters, numbers, symbols, geometrical figures, images, handwritten text, and the like (the same applies hereinafter).

Next, an operation concept of the mobile phone 100 according to the present embodiment will be described with reference to the flowchart shown in FIG. 3 and FIG. 4. Each function described in the flowchart is stored in a readable program code format, and operations in accordance with the program codes are sequentially performed in the mobile phone 100. Note that, in the mobile phone 100, operations in accordance with the program codes transmitted from a transmitting medium, such as a network, may be sequentially performed. That is, operations unique to the embodiment may be performed using programs and data provided from an external source via a transmitting medium, in addition to a recording medium.

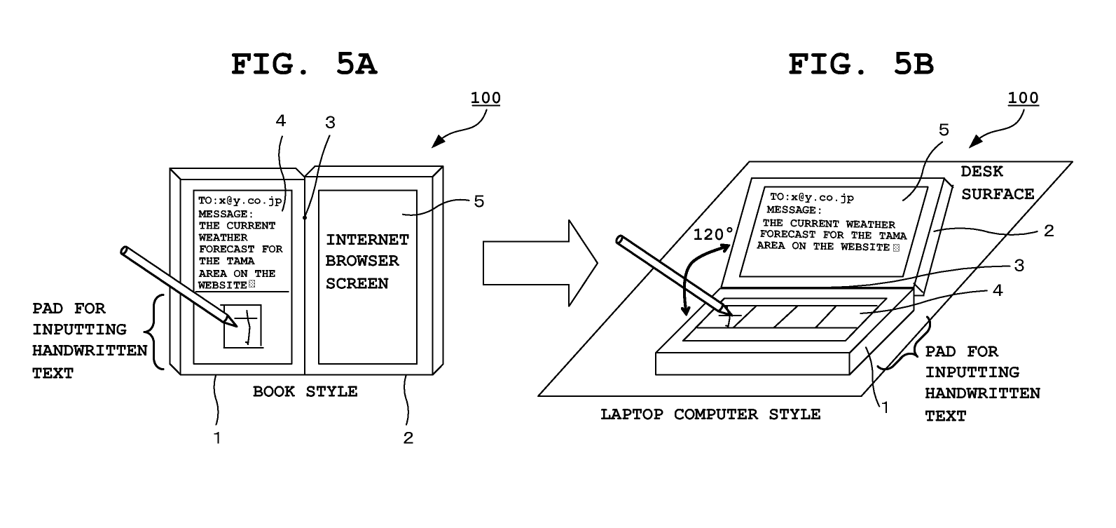

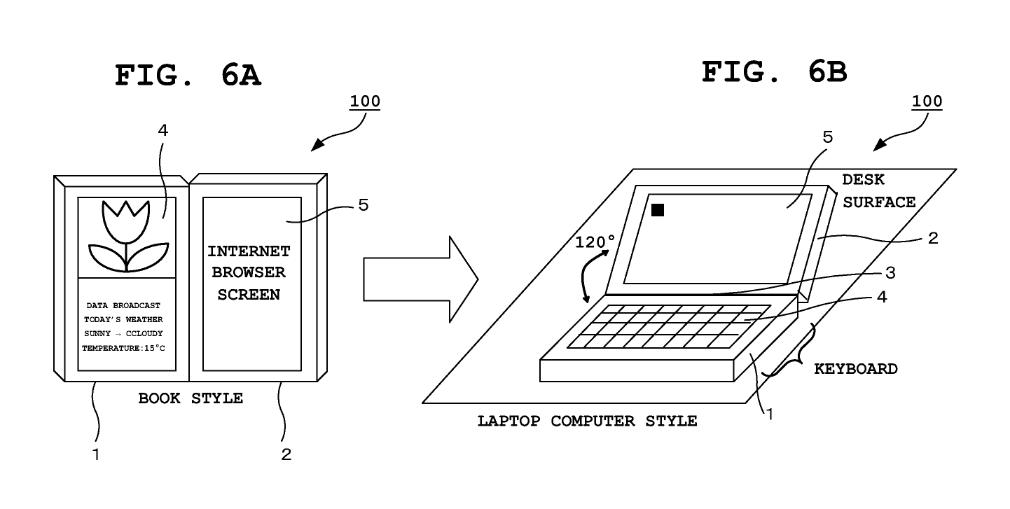

FIG. 3 and FIG. 4 are flowcharts outlining operations of the characteristic portion (application processing) of this embodiment from among all of the operations of the mobile phone 100. Note that, after exiting the flow in FIG. 3 and FIG. 4, the procedure returns to the main flow (not shown) of the overall operation. The flowcharts in FIG. 3 and FIG. 4 will hereinafter be described with reference to the detailed examples shown in FIG. 1A and FIG. 1B, FIG. 5A and FIG. 5B, and FIG. 6A and FIG. 6B.

First, when the user selects and designates each function (application) to be activated in order to activate two functions in the two display sections 4 and 5 (Step S1), the control section 11 activates the function designated for the first display section 4 and displays information acquired through the activation of the function in the display section 4 (Step S2). Then, the control section 11 activates the function designated for the second display section 5 and displays information acquired through the activation of the function in the display section 5 (Step S3).

Then, based on detection results from the opening angle detecting section 17 and the housing tilt detecting section 18, the control section judges whether or not the open/close state of the display section housings 1 and 2 is the book style shown in FIG. 1A (Step S4). When judged that the display section housings 1 and 2 are in an open/close state other than the book style (NO at Step S4), the control section 11 performs an operation in accordance with the mode of a usage style based on the open/close state (Step S5), and judges whether or not an end instruction to terminate the operation has been given (Step S6). When judged that an end instruction has not been given (NO at Step S6), the control section 11 returns to above-described Step S4. Conversely, when judged that an end instruction has been given (YES at Step S6), the control section 11 exits the flow in FIG. 3 and FIG. 4. Also, when judged that the display section housings 1 and 2 are in the book style (YES at Step S4), the control section 11 initiates an operation in accordance with the book-style mode (Step S7). Although not shown in the drawings, the control section 11 also exits the flow in FIG. 3 and FIG. 4 when an end instruction is given in the book style. In the book style, the control section 11 acquires a detection result from the housing tilt detecting section 18. Then, based on the detection result, the control section 11 judges whether or not one of the display section housings 1 and 2 is substantially horizontal with respect to the gravitational force direction (Step S8), and further judges whether or not a display section included in a substantially horizontal display section housing is facing upwards with respect to the gravitational force direction (Step S9).

When judged that one display section housing is not substantially horizontal with respect to the gravitational force direction (NO at Step S8), or that a display section included in a substantially horizontal display section housing is not facing upwards with respect to the gravitational force direction (NO at Step S9), the control section 11 returns to Step S4 and judges whether or not the display section housings 1 and 2 are in the book style. Conversely, when judged that one display section housing is substantially horizontal with respect to the gravitational force direction and further judged that the display section included in the substantially horizontal housing is facing upwards with respect to the gravitational force direction (YES at Steps S8 and S9), the control section 11 acquires a detection result from the opening angle detecting section 17, and judges whether or not the opening angle is substantially 120° (such as 100° to 140°) based on the detection result (Step S10). When judged that the opening angle is not substantially 120° (NO at Step S10), the control section 11 returns to Step S4 and judges whether or not the display section housings 1 and 2 are in the book style. Conversely, when judged that the opening angle is substantially 120° (YES at Step S10), the control section 11 judges that the display section housings 1 and 2 have been changed from the book style to the laptop computer style, and after proceeding to the flow in FIG. 4, performs processing in accordance with the laptop computer style.

In other words, the control section 11 judges whether or not at least one of the display sections 4 and 5 included in the display section housings 1 and 2 is performing display that requires text input (Step S11) When judged that at least one of the display sections 4 and 5 is performing display that requires text input (YES at Step S11), the control section 11 judges whether or not both display sections 4 and 5 in the display section housings 1 and 2 are performing display that requires text input (Step S12). When judged that only one display section is performing display that requires text input (NO at Step S12), the control section 11 continues the currently running function of the display section performing display that requires text input so that it is enabled (Step S13), and terminates the currently running function of the other display section so that it is disabled (Step S14). Then, the control section 11 proceeds to Step S18. In the example in FIG. 1A, the display section 4 displays a mail currently being created using a text input usage function (mail creating function), and the display section 5 displays an Internet browser launched by a viewing and listening function (internet browser function) that does not require text input. Accordingly, the mail creating function which is the text input usage function is enabled, and the internet browser function which is the viewing and listening function is disabled.

When judged at Step S12 that both display sections 4 and 5 are performing display that requires text input (YES at Step S12), the control section 11 judges which of the display section housing 1 and 2 is the substantially horizontal display section housing (Step S15). Then, the control section 11 continues the currently running function of a display section included in a substantially horizontal display section housing so that it is enabled (Step S16), and terminates the currently running function of a display section included in the other display section housing so that it is disabled (Step S17). For example, in a case where the display section housing 2 is substantially horizontal when a mail currently being created by the text input usage function (mail creating function) is displayed on the display section 4 and a document currently being created by the text input usage function (word processing function for creating documents) is displayed on the display section 5, the word processing function is enabled, and the mail creating function is disabled.

Next, the control section 11 references an input flag (not shown) optionally set by user operation in advance, and judges whether the software keyboard (touch-panel-type keyboard) has been selected or the software pad for inputting handwritten text (touch-panel-type pad for inputting handwritten text) has been selected as display for inputting text (Step S18). When judged that the software keyboard has been selected as display for inputting text (Step S18), the control section 11 displays the software keyboard (full keyboard) in the overall area of the display section included in the display section housing judged to be substantially horizontal at Step S15, and displays information acquired by the function enabled at Step S16 on the display section included in the other display section housing (Step S20). Then, the control section 11 initiates the operation of the currently enabled function as an operation in accordance with the laptop-computer-style mode (Step S21), and returns to Step S4 in FIG. 3.

In the example in FIG. 1B, the display section 4 included in the substantially horizontal display section housing 1 displays the software keyboard (full keyboard) as display for inputting text, and the display section 5 included in the other display section housing 2 continues the display of the content (the mail content being created) displayed on the display section 4 as display that requires text input in the book style shown in FIG. 1A. In this instance, the display section 5 is vertically long in the book style in FIG. 1A and is horizontally long in the laptop computer style in FIG. 1B. Accordingly, although the text entering start position, the number of lines, and the like change, the line-break position and the like remain the same.

When judged at Step S18 that the software pad for inputting handwritten text (touch-panel-type pad for inputting handwritten text) has been selected as display for inputting text (Step S18), the control section 11 displays the software pad for inputting handwritten text (a pad for inputting handwritten text which is used to input text amounting to a plurality of lines) in the overall area of the display section included in the display section housing judged to be substantially horizontal at Step S15 (Step S22), and displays information acquired by the function enabled at Step S16 on the display section included in the other display section housing (Step S23). Then, the control section 11 initiates the operation of the currently enabled function as an operation in accordance with the laptop-computer-style mode (Step S21), and returns to Step S4 in FIG. 3.

FIG. 5A and FIG. 5B show examples in which a software pad for inputting handwritten text has been displayed as display for inputting text. FIG. 5A shows a display state in the book style that is the same as that shown in FIG. 1A. On the lower half of the display section 4 included in the display section housing 1, a software pad for inputting handwritten text (a pad for inputting handwritten text which is used to input text amounting to a single line) on which the user inputs text by handwriting with a pen has been displayed instead of the software keyboard. On the upper half of the display section 4, a mail being created by the text input usage function (mail creating function) has been displayed. In addition, an Internet browser screen of the viewing and listening function (Internet browser function) has been displayed on the display section 5 included in the display section housing 2, as in the case of FIG. 1A.

FIG. 5B shows a display state in the laptop computer style that is the same as that shown in FIG. 1B. On the display section 4 included in the display section housing 1, a software pad for inputting handwritten text (such as a pad for inputting handwritten text which is used to input text amounting to four lines) has been displayed as display for inputting text. In addition, on the display section 5 included in the other display section housing 2, the contents displayed on the display section 4 in the book style shown in FIG. 5A as display that requires text input (the mail contents being created) has been continued to be displayed as they are.

When judged at Step S11 that neither of the display sections 4 and 5 is performing display that requires text input (NO at Step S11), or in other words, when judged that both display sections 4 and 5 are performing display for the viewing and listening function, the control section 11 terminates each of the currently running functions of the display sections 4 and 5 so that they are disabled (Step S24). Then, the control section 11 judges which of the display section housings 1 and 2 is the substantially horizontal display section housing (Step S25), and judges whether the software keyboard (touch-panel-type keyboard) has been selected or the software pad for inputting handwritten text (touch-panel-type pad for inputting handwritten text) has been selected as display for inputting text, with reference to the above-described input flag (not shown) (Step S26).

When judged that the software keyboard has been selected as display for inputting text (Step S26), the control section 11 displays the software keyboard (full keyboard) in the overall area of the display section included in the display section housing judged to be substantially horizontal at Step S25 (Step S27). Conversely, when judged that the software pad for inputting handwritten text (touch-panel-type pad for inputting handwritten text) has been selected as display for inputting text (Step S26), the control section 11 displays the software pad for inputting handwritten text (the pad for inputting handwritten text which is used to input text amounting to four lines) in the overall area of the display section included in the display section housing judged to be substantially horizontal at Step S25 (Step S28).

Then, after initiating a predetermined function that requires text input (such as the mail creating function, the word processor function, or a memo function) (Step S29), the control section 11 switches the display of the display section included in the other display section housing to the display of the predetermined function, such as the mail creating function, the word processor function or the memo function (Step S30). Note that this predetermined function is a function optionally selected and designated by user operation in advance (function that requires text input). However, the predetermined function is not limited thereto, and may be a fixed function. Then, the control section 11 initiates the operation of the predetermined function as an operation in accordance with the laptop-computer-style mode (Step S21) and returns to Step S4 in FIG. 3.

FIG. 6A and FIG. 6B are diagrams showing display examples when neither of the display sections 4 and 5 is performing display that requires text input. Specifically, FIG. 6A shows a display state in the book style that is the same as that in FIG. 1A. In FIG. 6A, a television function has been activated as the viewing and listening function in the display section 4 included in the display section housing 1, and accordingly a television screen received by the television broadcast receiving section 16 has been displayed on the display section 4. In addition, the viewing and listening function (internet browser function) has been activated in the display section 5 included in the display section housing 2, and accordingly an internet browser screen has been displayed on the display section 5, as in the case of FIG. 1A.

FIG. 6B shows a display state in the laptop computer style when the display section housings 1 and 2 are changed from the book style to the laptop computer style that is the same as that in FIG. 1B while the display sections 4 and 5 are each performing display for the viewing and listening function and therefore not performing display that requires text input. That is, in the laptop computer style, the software keyboard (touch-panel-type full-keyboard) is displayed as display for inputting text on the display section 4 included in the display section housing 1, and a predetermined function is displayed on the display section 5 included in the display section housing 2, as in the case of FIG. 1B. In the example in FIG. 6B, an input screen for the mail creating function is displayed on the display section 5.

As described above, in the present embodiment, the display section housing 1 including the display section 4 and the display section housing 2 including the display section 5 are foldably connected via the hinge section 3. In this state, when the control section 11 judges that one of the display section housings 1 and 2 is substantially horizontal with respect to the gravitational force direction and the display section included in the substantially horizontal display section housing is facing upwards with respect to the gravitational force direction, and further judges that the opening angle of the display section housings 1 and 2 is greater than a predetermined angle, the display of the display section included in the display section housing judged to be substantially horizontal with respect to the gravitational force direction is switched to display for inputting text. Therefore, the display of either display section can be switched to display for inputting text in accordance with the intentions of the user attempting to perform text input, simply by the display section housings 1 and 2 being changed from the book style to the laptop computer style, without a special key operation being performed. Thus, the user-friendliness is improved.

In addition, the display for inputting text is the software keyboard, and therefore the display of either display section can be switched to the software keyboard in accordance with the intentions of the user, without a special key operation being performed.

Moreover, the pad for inputting handwritten text can be selected as the display for inputting text, and therefore the display of either display section can be switched to the pad for inputting handwritten text in accordance with the intentions of the user, without a special key operation being performed.

Furthermore, according to the present embodiment, when display requiring text input is performed in at least one of the two display sections 4 and 5 the display of a display section that is facing upwards with respect to the gravitational force direction and included in a display section housing that is substantially horizontal with respect to the gravitational force direction is switched to display for inputting text, and the display of a display section included in the other display section housing is switched to the above-described display that requires text input. Therefore, the user can easily switch the mobile phone 100 to a state in which text can be input in an intended display that requires text input.

Still further, when display requiring text input is performed in both display sections 4 and 5, the display of a display section included in a display section housing that is substantially horizontal with respect to the gravitational force direction is switched to the display of a display section included in the other display section housing. Therefore, even when display requiring text input is performed in both display sections 4 and 5, the user can easily switch either display section to a state in which text can be input by positioning its display section housing to be substantially horizontal.

Yet still further, when display requiring text input is not performed in either display section 4 or 5, the display of a display section that is facing upwards with respect to the gravitational force direction and included in a display section housing that is substantially horizontal with respect to the gravitational force direction is switched to display for inputting text, and the display of a display section included in the other display section housing is switched to the above-described display that requires text input. Therefore, for example, when the user needs to send an electronic mail while viewing the internet browser screen of the viewing and listening function or watching a television broadcast, the user can switch the mobile phone 100 to a state where the person can input text, without performing a special key operation.

Note that, although the predetermined opening angle in the above-described embodiment is substantially 120°, this angle is not limited thereto and may be arbitrarily determined. In addition, a configuration may be adopted in which the predetermined opening angle can be set by user operation.

Also, in the above-described embodiment, an example has been described where the vertically long display section housings 1 and 2 are switched from the book style, in which they are in an opened state so as to be horizontally aligned (horizontally opened state), to the laptop computer style. However, the same processing may be performed, for example, when horizontally long display section housings 1 and 2 are switched from a style (DS style) where they are in an opened state so as to be vertically aligned (vertically opened state) to the laptop computer style. In this case, a configuration may be adopted in which, when the display section housings 1 and 2 are switched from the DS style to the laptop computer style while a mail list is being displayed in the upper display section and a mail message is being displayed in the lower display section, a keyboard/pad for inputting handwritten text is displayed on the display section of a substantially horizontal display section housing, and the display section of the other display section housing is switched to display for replying to mail.

Furthermore, in the above-described embodiments, the present invention has been applied to a foldable-type mobile phone. However, the structure of the mobile phone is not limited thereto, and an optional housing structure such as a double-axis hinged-type, a sliding-type, or a rotating-type may be used. In addition, the present invention may be applied not only to a mobile phone but also to a personal computer, a personal digital assistant (PDA), a digital camera, a music player, etc.

Still further, the “devices” or the “units” described in each of the above-described embodiments are not required to be in a single housing, and may be separated into a plurality of housings by function. In addition, the steps in the above-described flowcharts are not required to be processed in time series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. A terminal device which includes two housings respectively having a display section which are foldably connected via a hinge section, comprising:
a tilt judgment means for detecting an angle of each housing with respect to a gravitational force direction, and judging whether or not either one of the two housings is substantially horizontal with respect to the gravitational force direction and the display section included in the substantially horizontal housing is facing upwards with respect to the gravitational force direction;
an opening angle judgment means for detecting an opening angle of the two housings, and judging whether or not the opening angle is greater than a predetermined angle; and
a display control means for switching display of the display section included in a housing judged to be substantially horizontal with respect to the gravitational force direction to display for inputting text, when the tilt judgment means judges that one housing is substantially horizontal with respect to the gravitational force direction and the display section included in the substantially horizontal housing is facing upwards with respect to the gravitational force direction, and the opening angle judgment means judges that the opening angle is greater than the predetermined angle.

2. The terminal device according to claim 1, wherein the display for inputting text, to which the display of the display section included in the housing judged to be substantially horizontal with respect to the gravitational force direction is switched by the display control means, is a software keyboard.

3. The terminal device according to claim 1, wherein the display for inputting text, to which the display of the display section included in the housing judged to be substantially horizontal with respect to the gravitational force direction is switched by the display control means, is display for inputting handwritten text.

4. The terminal device according to claim 1, further comprising:
a text input judgment means for judging whether or not at least one of the two display sections is performing display that requires text input;
wherein the display control means switches the display of the display section that is facing upwards with respect to the gravitational force direction and included in the housing that is substantially horizontal with respect to the gravitational force direction to the display for inputting text, and switches display of the display section included in the other housing to the display being performed by the display section judged to be performing the display that requires text input by the text input judgment means, when the text input judgment means judges that at least one of the two display sections is performing the display that requires text input.

5. The terminal device according to claim 4, wherein the display control means switches the display of the display section included in the housing that is substantially horizontal with respect to the gravitational force direction to the display of the display section included in the other housing, when the text input judgment means judges that both of the two display sections are performing the display that requires text input.

6. The terminal device according to claim 1, further comprising:
a text input judgment means for judging whether or not at least one of the two display sections is performing display that requires text input;
wherein the display control means switches the display of the display section that is facing upwards with respect to the gravitational force direction and included in the housing that is substantially horizontal with respect to the gravitational force direction to the display for inputting text, and switches display of the display section included in the other housing to display of a predetermined function that requires text input, when the text input judgment means judges that neither of the two display sections is performing the display that requires text input.

7. A non-transitory computer-readable storage medium having stored thereon a program that is executable by a computer, the program being executable by the computer to perform functions comprising:
processing for detecting angles of two housings respectively having a display section which are foldably connected via a hinge section, with respect to a gravitational force direction, and judging whether or not either one of the two housings is substantially horizontal with respect to the gravitational force direction and the display section included in the substantially horizontal housing is facing upwards with respect to the gravitational force direction;
processing for detecting an opening angle of the two housings, and judging whether or not the opening angle is greater than a predetermined angle; and
processing for switching display of the display section included in the housing judged to be substantially horizontal with respect to the gravitational force direction to display for inputting text, when one housing is judged to be substantially horizontal with respect to the gravitational force direction, the display section included in the substantially horizontal housing is judged to be facing upwards with respect to the gravitational force direction, and the opening angle is judged to be greater than the predetermined angle.
